(19) United States
(12) Patent Application Publication
(10) Pub. No.: US 2024/0184743 A1
(43) Pub. Date: Jun. 6, 2024

(54) USING TELEMETRY DATA TO PREDICT SYSTEM PERFORMANCE

(71) Applicant: Salesforce, Inc., San Francisco, CA (US)

(72) Inventors: Gautham Ramachandran, Campbell, CA (US); Ana Bertran, San Francisco, CA (US); Gopinath Krishnan Vinodh, San Francisco, CA (US)

(21) Appl. No.: 18/062,346

(22) Filed: Dec. 6, 2022

(51) Int. Cl. G06F 16/11

(52) U.S. Cl. CPC G06F 16/122

(57) ABSTRACT

A method for data processing is described. The method includes acquiring telemetry data for multiple client systems supported by a cloud service that controls electronic communications between the client systems and users associated with the client systems. The method further includes filtering the client systems to identify one or more client systems having attributes that satisfy a similarity threshold with respect to attributes associated with a first client system. The method further includes determining a configuration for the first client system based on the telemetry data associated with the identified client systems. The method further includes executing a communication process flow between the first client system and two or more users associated with the first client system in accordance with the configuration. The method further includes obtaining telemetry data for the first client system based on the communication process flow.

### FIELD OF TECHNOLOGY

The present disclosure relates generally to database systems and data processing, and more specifically to using telemetry data to predict system performance.

### BACKGROUND

A cloud platform (i.e., a computing platform for cloud computing) may be employed by multiple users to store, manage, and process data using a shared network of remote servers. Users may develop applications on the cloud platform to handle the storage, management, and processing of data. In some cases, the cloud platform may utilize a multi-tenant database system. Users may access the cloud platform using various user devices (e.g., desktop computers, laptops, smartphones, tablets, or other computing systems).

In one example, the cloud platform may support customer relationship management (CRM) solutions. This may include support for sales, service, marketing, community, analytics, applications, and the Internet of Things. A user may utilize the cloud platform to help manage contacts of the user. For example, managing contacts of the user may include analyzing data, storing and preparing communications, and tracking opportunities and sales.

In another example, the cloud platform may provide users with marketing tools and automation. For example, the cloud platform may enable a user to automatically distribute electronic content to other users. As the cloud platform distributes the electronic content, the cloud platform may track and store performance-related information associated with a given processing task (e.g., distributing an advertisement to a set of users). Administrators of the cloud platform may use this information to evaluate the performance of such processing tasks.

### BRIEF DESCRIPTION OF THE DRAWINGS

FIGS. 1 and 2 illustrate examples of data processing systems that support using telemetry data to predict system performance in accordance with one or more aspects of the present disclosure.

FIG. 3 illustrates an example of a telemetry acquisition scheme that supports using telemetry data to predict system performance in accordance with one or more aspects of the present disclosure.

FIG. 4 illustrates an example of a proxy generation scheme that supports using telemetry data to predict system performance in accordance with one or more aspects of the present disclosure.

FIG. 5 illustrates an example of a process flow that supports using telemetry data to predict system performance in accordance with one or more aspects of the present disclosure.

FIG. 6 illustrates a block diagram of an apparatus that supports using telemetry data to predict system performance in accordance with one or more aspects of the present disclosure.

FIG. 7 illustrates a block diagram of a telemetry manager that supports using telemetry data to predict system performance in accordance with one or more aspects of the present disclosure.

FIG. 8 illustrates a diagram of a system including a device that supports using telemetry data to predict system performance in accordance with one or more aspects of the present disclosure.

FIGS. 9 and 10 illustrate flowcharts showing methods that support using telemetry data to predict system performance in accordance with one or more aspects of the present disclosure.

### DETAILED DESCRIPTION

A cloud platform may provide users with a variety of customer relationship management (CRM) solutions, application development services, and marketing automation tools. In some cases, the cloud platform may support a cloud service (also referred to as Commerce Cloud or Marketing Cloud) that enables users to orchestrate and execute marketing activities at scale. The cloud service may automatically deliver marketing content (e.g., emails, advertisements, promotions) to customers of a client system according to various user-selected criteria. In some cases, the cloud service may track and aggregate telemetry data (also referred to as health signals or service health data) for each client system. This telemetry data may include key performance indicators (KPIs) related to latency, request volume, request saturation, resource utilization, etc.

The cloud service may use telemetry data to assess the overall performance of communication process flows associated with a client system (e.g., a customer of the cloud service). As described herein, a communication process flow may refer to a marketing campaign that users can develop, orchestrate, and execute using resources provided by the cloud service. In some cases, the cloud service may adjust the configuration (e.g., hardware settings, workload distribution) of a client system to improve the performance of communication process flows associated with the client system. However, the cloud service may be unable to evaluate and/or predict the performance of onboarding customers with limited telemetry data. Also, the cloud service may be unable to leverage telemetry data associated with first-party (1P) client systems (for example, customers that use resources provided by the cloud platform) to assess and/or predict the performance of third-party (3P) client systems (for example, customers that use resources provided by other cloud-based services).

The techniques described herein support using historic 1P telemetry data to evaluate the performance of onboarding client systems and/or client systems hosted in 3P computing environments. In accordance with aspects of the present disclosure, the cloud service may identify a set of 1P client systems with attributes (e.g., geographic location, size, category) similar to those of an onboarding client system, and may use telemetry data associated with the identified set of 1P client systems to predict a compatible setup (e.g., hardware configuration, quantity of processing resources) for the onboarding client system. The cloud service may also use event-related information associated with the identified set of 1P client system to predict the timing and size of specific trends (for example, holiday sale spikes, cyber-week promotional activities) for the onboarding client system. Once the onboarding process is complete, the cloud service may augment the initial data set (e.g., the telemetry data associated with the identified set of 1P client systems) with actual telemetry data acquired from communication process flows associated with the onboarded client system.

In some examples, the cloud service may adjust the initial configuration of the onboarding client system based on real-time telemetry data gathered from ongoing communication process flows. The cloud service may also track various performance-related proxies (such as paid search clicks or volume-adjusted email clicks) to estimate the effect of marketing activities on outcomes such as revenue, sales, etc. In some examples, the cloud service may store telemetry data for 3P client systems on 1P resources such that the telemetry data is unavailable/inaccessible to 3P cloud providers. Additionally, or alternatively, the cloud service may use real-time and/or pattern-matched telemetry data (e.g., historic 1P telemetry data that has been filtered based on an attribute profile of the onboarding client system) to determine a service health score for the onboarding client system.

Aspects of the present disclosure may be implemented to realize one or more of the following advantages. The techniques described herein may enable a cloud service to predict telemetry benchmarks and baseline performance metrics for an onboarding client system based on historic telemetry data associated with similar client systems. For example, the described techniques may enable the cloud service to extrapolate and/or transform telemetry data associated with a peer client system to determine a set of baseline metrics to use for evaluating the performance of processing tasks associated with the onboarding client system. Likewise, the cloud service may use 1P telemetry data to determine a suitable type and/or quantity of 3P hardware resources to allocate for the onboarding client system, which may improve the performance of communication process flows and other processing tasks associated with the onboarding client system.

Aspects of the disclosure are initially described in the context of data processing systems, telemetry acquisition schemes, proxy generation schemes, and process flows. Aspects of the disclosure are further illustrated by and described with reference to apparatus diagrams, system diagrams, and flowcharts that support using telemetry data to predict system performance.

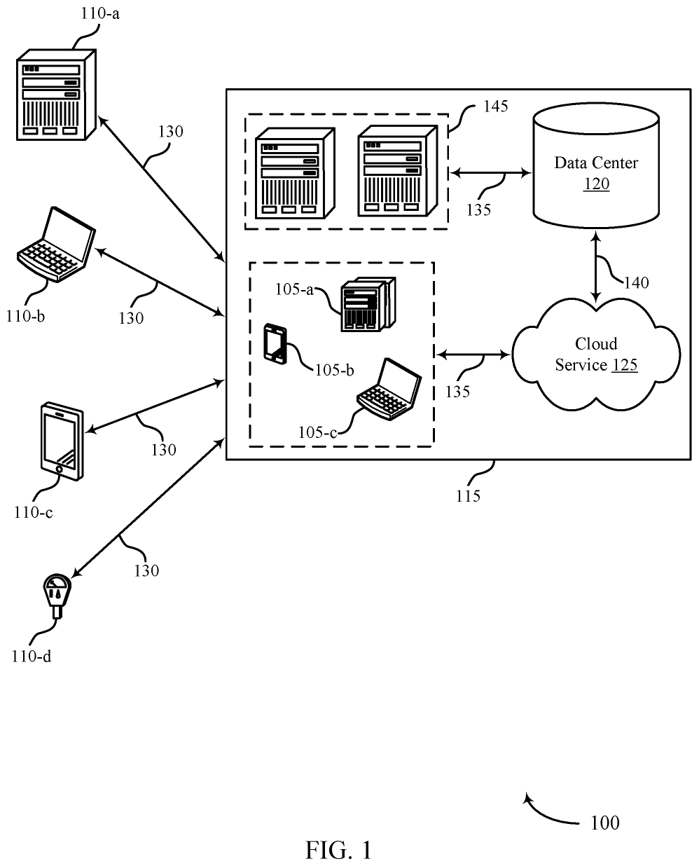

FIG. 1 illustrates an example of a data processing system 100 for cloud computing that supports using telemetry data to predict system performance in accordance with various aspects of the present disclosure. The data processing system 100 includes cloud clients 105, contacts 110, cloud platform 115, and data center 120. Cloud platform 115 may be an example of a public or private cloud network. A cloud client 105 may access cloud in platform 115 over network connection 135. The network may implement transfer control protocol and internet protocol (TCP/IP), such as the Internet, or may implement other network protocols. A cloud client 105 may be an example of a user device, such as a server (e.g., cloud client 105-a), a smartphone (e.g., cloud client 105-b), or a laptop (e.g., cloud client 105-c). In other examples, a cloud client 105 may be a desktop computer, a tablet, a sensor, or another computing device or system capable of generating, analyzing, transmitting, or receiving communications. In some examples, a cloud client 105 may be operated by a user that is part of a business, an enterprise, a non-profit, a startup, or any other organization type.

A cloud client 105 may interact with multiple contacts 110. The interactions 130 may include communications, opportunities, purchases, sales, or any other interaction between a cloud client 105 and a contact 110. Data may be associated with the interactions 130. A cloud client 105 may access cloud platform 115 to store, manage, and process the data associated with the interactions 130. In some cases, the cloud client 105 may have an associated security or permission level. A cloud client 105 may have access to certain applications, data, and database information within cloud platform 115 based on the associated security or permission level, and may not have access to others.

Contacts 110 may interact with the cloud client 105 in person or via phone, email, web, text messages, mail, or any other appropriate form of interactions 130. The interactions 130 may be a business-to-business (B2B) interaction or a business-to-consumer (B2C) interaction. A contact 110 may also be referred to as a customer, a potential customer, a lead, a client, or some other suitable terminology. In some cases, the contact 110 may be an example of a user device, such as a server (e.g., contact 110-a), a laptop (e.g., contact 110-b), a smartphone (e.g., contact 110-c), or a sensor (e.g., contact 110-d). In other cases, the contact 110 may be another computing system. In some cases, the contact 110 may be operated by a user or group of users. The user or group of users may be associated with a business, a manufacturer, or any other appropriate organization.

Cloud platform 115 may offer an on-demand database service to the cloud client 105. In some cases, cloud platform 115 may be an example of a multi-tenant database system. In this case, cloud platform 115 may serve multiple cloud clients 105 with a single instance of software. However, other types of systems may be implemented, including—but not limited to—client-server systems, mobile device systems, and mobile network systems. In some cases, cloud platform 115 may support CRM solutions. This may include support for sales, service, marketing, community, analytics, applications, and the Internet of Things. Cloud platform 115 may receive data associated with interactions 130 from the cloud client 105 over a network connection 135, and may store the data for further analysis. In some cases, cloud platform 115 may receive data directly from interactions 130 between a contact 110 and the cloud client 105. In some cases, the cloud client 105 may develop applications to run on cloud platform 115. Cloud platform 115 may be implemented using remote servers. In some cases, the remote servers may be located at the data center 120.

Data center 120 may be coupled (e.g., operatively, communicatively, functionally, electronically, or electrically) with one or more servers 145. The servers 145 may be used for data storage, management, and processing. Data center 120 may receive data from cloud platform 115 via connection 140, or directly from the cloud client 105 or interactions 130 between a contact 110 and the cloud client 105. Data center 120 may utilize multiple redundancies for security purposes. In some cases, the data stored at data center 120 may be backed up by copies of the data at a different data center (not shown).

The cloud platform 115 may support a cloud service 125 that manages communication process flows between cloud clients 105 and contacts 110. In some cases, data processing may occur at any of the components of cloud platform 115, or at a combination of these components. In some cases, the servers 145 may perform the data processing. In some examples, the servers 145 may be logically and/or physically co-located. In other examples, the servers 145 may be located in different geographic regions, computing environments, etc.

The data processing system 100 may be an example of a multi-tenant system. For example, the data processing system 100 may store data and provide applications, solutions, or any other functionality for multiple tenants concurrently. A tenant may be an example of a group of users (e.g., an organization) associated with a same tenant identifier (ID) who share access, privileges, or both for the data processing system 100. The data processing system 100 may effectively separate data and processes for a first tenant from data and processes for other tenants using a system architecture, logic, or both that support secure multi-tenancy. In some examples, the data processing system 100 may include or be an example of a multi-tenant database system.

A multi-tenant database system may store data for different tenants in a single database or a single set of databases. For example, the multi-tenant database system may store data for multiple tenants within a single table (e.g., in different rows) of a database. To support multi-tenant security, the multi-tenant database system may prohibit (e.g., restrict) a first tenant from accessing, viewing, or interacting in any way with data or rows associated with a different tenant. As such, tenant data for the first tenant may be isolated (e.g., logically isolated) from tenant data for a second tenant, and the tenant data for the first tenant may be invisible (or otherwise transparent) to the second tenant. The multi-tenant database system may additionally use encryption techniques to further protect tenant-specific data from unauthorized access (e.g., by another tenant).

Additionally, or alternatively, the multi-tenant system may support multi-tenancy for software applications and infrastructure. In some cases, the multi-tenant system may maintain a single instance of a software application and architecture supporting the software application in order to serve multiple different tenants (e.g., organizations, customers). For example, multiple tenants may share the same software application, the same underlying architecture, the same resources (e.g., compute resources, memory resources), the same database, the same servers or cloud-based resources, or any combination thereof. For example, the data processing system 100 may run a single instance of software on a processing device (e.g., a server, server cluster, virtual machine) to serve multiple tenants. Such a multi-tenant system may provide for efficient integrations (e.g., using application programming interfaces (APIs)) by applying the integrations to the same software application and underlying architectures supporting multiple tenants. In some cases, processing resources and/or memory resources may be shared by multiple tenants.

As described herein, the data processing system 100 may support any configuration for providing multi-tenant functionality. For example, the data processing system 100 may organize resources (e.g., processing resources, memory resources) to support tenant isolation (e.g., tenant-specific resources), tenant isolation within a shared resource (e.g., within a single instance of a resource), tenant-specific resources in a resource group, tenant-specific resource groups corresponding to a same subscription, tenant-specific subscriptions, or any combination thereof. The data processing system 100 may support scaling of tenants within the multi-tenant system, for example, using scale triggers, automatic scaling procedures, scaling requests, or any combination thereof. In some cases, the data processing system 100 may implement one or more scaling rules to enable relatively fair sharing of resources across tenants. For example, a tenant may have a threshold quantity of processing resources, memory resources, or both to use, which in some cases may be tied to a subscription by the tenant.

In accordance with one or more aspects of the present disclosure, the cloud service 125 (also referred to herein as Marketing Cloud or Commerce Cloud) may collect telemetry data for different cloud clients 105 (e.g., client systems, customers). However, the cloud service 125 may not have access to telemetry data for onboarding customers, such as the cloud client 105-b. To obtain telemetry data for the cloud client 105-b, the cloud service 125 may use various attributes of the cloud client 105-b (e.g., size, location, send type) to identify a suitable group of peer customers (for example, the cloud client 105-a and/or the cloud client 105-c). The cloud service 125 may use pattern-matched telemetry data associated with the identified peer customers to determine suitable benchmarks and baseline performance metrics for the cloud client 105-b. As described herein, pattern matching may refer to the process of identifying peer customers with similar attributes, aggregating telemetry data associated with the identified peer customers, and transforming the aggregated telemetry data (for example, using averaged weighting techniques, linear regression, and/or extrapolation) to match the profile of the cloud client 105-b.

Accordingly, the cloud service 125 may execute one or more communication process flows for the cloud client 105-b, and may and use incoming telemetry data from the communication process flow to adjust the group of peer customers and/or the configuration of the cloud client 105-b. In some examples, the cloud service 125 may use historic 1P data to predict/project 3P benchmarks for the cloud client 105-b. The cloud service 125 may use historic 1P data to project 3P telemetric data that can be used to derive benchmarks for the cloud client 105-b. The cloud service 125 may adjust factors such as hardware stock keeping unit (SKU), server location, and processing resource allocation based on the incoming telemetry data. The cloud service 125 may add or remove cloud clients 105 from the group of peer customers based on incoming telemetry signals from communication process flow(s) associated with the cloud client 105-b.

In some examples, the cloud service 125 may use client-level service health score matrix validation (between 3P and 1P) in combination with other segmentation and benchmarking processes. The cloud service 125 may evaluate or adjust parameters (such as message complexity or transfer agent configuration) to improve the service health of the cloud client 105-b. The cloud service 125 may use weighted averaging techniques to identify the group of peer customers. The cloud service 125 may generate outcome proxies (e.g., paid search clicks, conversions, latency health scores) based on actual data that results from epochal marketing events. The cloud service 125 may use these proxies to determine whether a configuration of the cloud client 105-b adversely affected the correlated outcomes.

In some cases, to limit data exposure, 1P service health data may not be uploaded to 3P computing systems. The cloud service 125 may use an iterative feedback loop to refine and/or update the group of peer customers. In some examples, the group of peer customers may be hosted in a 1P computing environment, while the cloud client 105-b may be hosted in a 3P computing environment. The cloud service 125 may filter the group of peer customers according to relative size, geography, operational category, etc.

It should be appreciated by a person skilled in the art that one or more aspects of the disclosure may be implemented in a data processing system 100 to additionally or alternatively solve other problems than those described above. Furthermore, aspects of the disclosure may provide technical improvements to “conventional” systems or processes as described herein. However, the description and appended drawings only include example technical improvements resulting from implementing aspects of the disclosure, and accordingly do not represent all of the technical improvements provided within the scope of the claims.

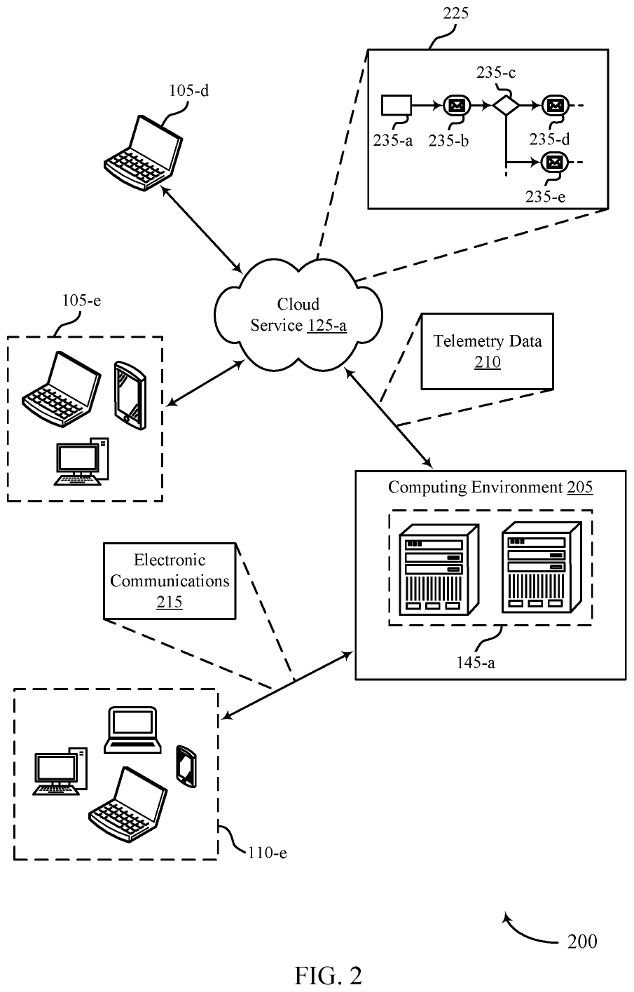

FIG. 2 illustrates an example of a data processing system 200 that supports using telemetry data to predict system performance in accordance with one or more aspects of the present disclosure. The data processing system 200 may implement or be implemented by aspects of the data processing system 100, as described with reference to FIG. 1. For example, the data processing system 200 includes a cloud service 125-a, a cloud client 105-d, and contacts 110-e, which may be examples of corresponding elements described with reference to FIG. 1. In the example of FIG. 2, the cloud service 125-a may predict various telemetry benchmarks and baseline performance metrics for the cloud client 105-d (e.g., an onboarding client system) using historic telemetry data associated with a group of 1P cloud clients 105-e.

As described herein, the cloud service 125-a may support creation, configuration, and implementation of various communication process flows (such as a communication process flow 225) that control electronic communications 215 between the cloud client 105-d and contacts 110-e associated with the cloud client 105-d. For example, users associated with the cloud client 105-d may use the cloud service 125-a to develop, execute, and manage electronic communications between the cloud client 105-d and the contacts 110-e. The communication process flow 225 may include an action 235-a associated with instructions that, when executed by a processor, select contacts 110-e (e.g., customers) for the communication process flow 225. In other words, the action 235-a may define a rule for determining whether the contacts 110-e are to receive electronic communications 215 in accordance with the communication process flow 225. The rule may be based on various attributes and behaviors (e.g., demographic information, web activity patterns, purchase history) of the contacts 110-e. For example, users that have purchased a product from the cloud client 105-d (or an organization associated with the cloud client 105-d) in the last six months may receive electronic communications 215 from the cloud client 105-d in accordance with the communication process flow 225. The contacts 110-e that do not satisfy these criteria may not receive electronic communications 215 in accordance with the communication process flow 225.

Other actions may define message transmission schemes, decision splits, and other related processes. For example, each user that satisfies a rule defined by the action 235-a may receive an email according to an action 235-b. The action 235-b may include specific content that is to be transmitted to the contacts 110-e (e.g., via email). Similarly, an action 235-c may define a decision split between users. For example, users that have opened an email corresponding to the action 235-b may be routed to an action 235-d, while users that have not opened the email corresponding to the action 235-b may be routed to an action 235-e. Additionally or alternatively, the action 235-c (e.g., a decision split) may leverage other attributes and behaviors to route users through the communication process flow 225.

The techniques and telemetry prediction schemes disclosed herein may enable the cloud service 125-a to adjust and/or improve aspects of the communication process flow 225. For example, the cloud service 125-a may use 1P health signals (also referred to herein as telemetry data or performance metrics) in combination with effective customer categorization and signal-level pattern matching schemes to adapt historic system health signals for monitoring, managing and predicting the service health of onboarding customers that do not have historic telemetry data (in 1P or 3P computing environments). In other words, the cloud service 125-a may augment onboarding customer data with pattern-matched data based on service health scores of similar 1P cloud clients 105-e.

In some example, the underlying pattern-matched telemetry data may be moved to 3P if the cloud client 105-d operates using 3P resources, such as servers 145-a that are configured to execute the communication process flow 225 within the computing environment (e.g., a 3P cloud system). In such examples, the cloud service 125-a may apply iterative validation based on real-time telemetry data 210 as this data arrives from the computing environment 205. If there is a discrepancy between the pattern-matched telemetry data and the real-time telemetry data 210, the cloud service 125-a can adjust the pattern-matched telemetry data (e.g., the historic 1P telemetry data associated with the cloud clients 105-e) by selecting and/or iteratively request-based weight averaging over other candidates, one at a time.

The telemetry prediction schemes described herein may reduce the amount of unused historic signal health data from 1P systems, and may be applicable to 1P customers (customers being onboarded to the cloud service 125-a) and 3P customers (customers onboarded to the computing environment 205). For 1P customers, the cloud service 125-a may augment 1P customer data with pattern-matched data based on service health scores (e.g., performance scores) associated with similar 1P customers. In such implementations, there is no need to migrate pattern-matched telemetry data due to the underlying pattern-matching algorithm. For 3P customers, the cloud service 125-a may augment 3P customer data with pattern-matched data based on service health scores from similar 1P customers. In such implementations, the cloud service 125-a may transform or migrate pattern-matched signals to augment service health monitoring for the 3P customer.

The techniques described herein may enable the cloud service 125-a to predict the health of 3P customers using pattern-matched signals (historic 1P telemetry data) from pre-existing 1P customers. Once the cloud service 125-a has collected a sufficient amount of 3P telemetry data (>12 months), the cloud service 125-a may gradually transition to using only 3P data. The cloud service 125-a may include a number of different sub-systems that execute different aspects of the telemetry prediction schemes disclosed herein. For example, the cloud service 125-a may include a service heath estimating sub-system that tracks request volume, errors, average duration, and saturation. This sub-system may estimate the overall service health of customers at the service-level. The cloud service 125-a may also include a signal pattern matching sub-system that controls pattern matching based on historic 1P health signals, orchestrates customer matching, and manages signal averaging for all matched customers and/or prioritized selections using an iterative feedback loop. The signal pattern matching sub-system may also compute and apply hardware gain scores for onboarding client systems.

Additionally, the cloud service 125-a may include a signal porting component that ports pattern-matched signals to other computing systems (such as the computing environment 205). The cloud service 125-a may also include a benchmarking component that controls benchmarking processes and service health comparisons using an iterative pattern matching feedback loop and determines causal inferences for revenue/conversions (and corresponding proxies) from the cloud service 125-a for the onboarding customer for specific marketing events using an iterative pattern matching feedback loop. In addition, the cloud service 125-a may include a service health forecasting system that ensures 3P readiness using historic 1P signals.

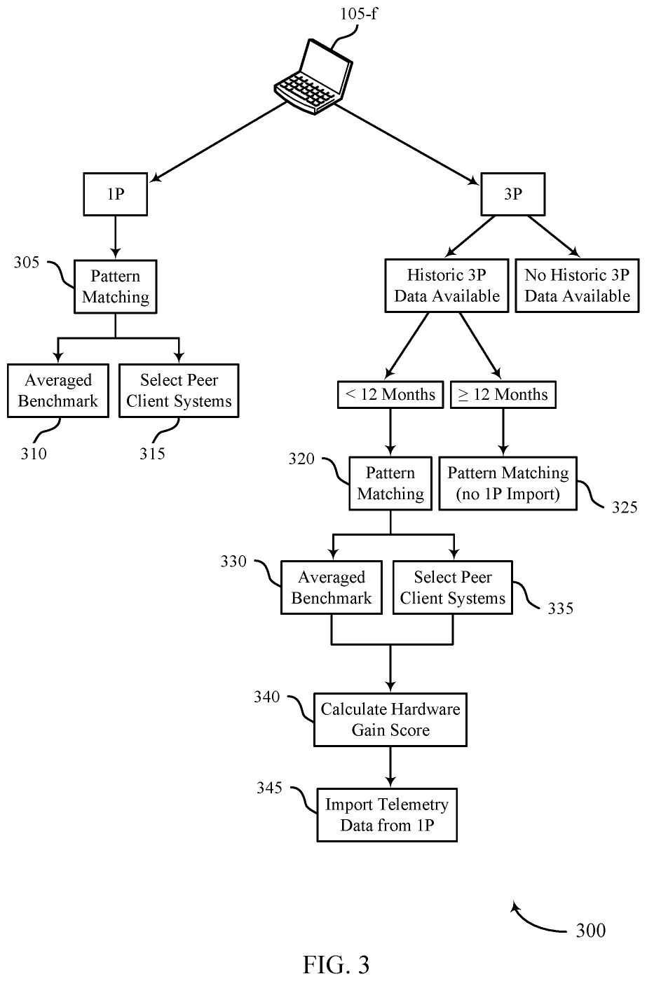

FIG. 3 illustrates an example of a telemetry acquisition scheme 300 that supports using telemetry data to predict system performance in accordance with one or more aspects of the present disclosure. The telemetry acquisition scheme 300 may implement or be implemented by aspects of the data processing system 100 or the data processing system 200. For example, the telemetry acquisition scheme 300 may be implemented by a cloud service, such as the cloud service 125-a described with reference to FIG. 2. In accordance with the telemetry acquisition scheme 300, the cloud service may leverage historic 1P telemetry data to improve the accuracy and efficiency of onboarding operations for a cloud client 105-f.

To onboard new customers (also referred to as onboarding client systems), custom service-level agreement (SLA)-based service health signals and measurements based on telemetry signals for marketing systems may be used to identify a group of peer customers (customers with similar attributes) using filtering criteria (size, classification, geography) and pattern matching. Moving the resulting signals to 3P provides a plausible application. Pattern matching provides at least three options for telemetry augmentation: weighted averaging across all customers, best-fit customers, and weighted averaging across a subset of the best-fit customers.

The approaches described herein leverage iterative feedback mechanisms based on actual signals and/or augmented 1P historic signals to identify how many pattern-matched customers to include such that the estimated/averaged signal used to augment the onboarding 1P/3P customer and the ranking against the peer set is not off by more than a quartile. Statistical significance testing on the SLA-based health score for augmented signals and SLA-based health based on actual signals for the onboarding customer (e.g., the cloud client 105-f) may be treated as independent. Unbalanced samples with at least a 90% confidence level may be used to augment the iterative feed-back loop.

Once the pattern-matched signal options for onboarding customer augmentations have been identified, Bayesian causal inference (based on revenue/conversions for the customer after 1P/3P onboarding market) may be matched to synthetic controls of peer-based baseline service health score signals and associated geographic regions to ensure no adverse impact before and after epochal marketing events. Identifying the correct pattern-matched signals, adjusting and validating baseline metrics using causal and peer-based comparison frameworks to migrate 1P/3P transitions, and using historical 1P signals to manage 3P service health periods of high activity (such as Cyber Week, Holiday Season, President's Day) for onboarding customers with little to no historical data may facilitate early and ongoing success.

Cloud-based marketing services face considerable seasonality (with respect to hour of day, day of week, holidays) in terms of send volumes and message complexity, which can impact the service health of systems executing marketing campaigns. Filtering criteria used for signal validation based on pattern-matched health score computations between 1P/3P include size, geography, and operational correlations to anonymize historic signals. The cloud service may identify a group of customers according to these filtering criteria, and may use requests to pattern-match signals and identify similar customers with historic signals to augment onboarding customer signals. The cloud service may ensure anonymity of pre-existing 1P customers and customization of best-fit historic 1P signals. The cloud service may use customer-level service health score matrix validation between 3P and 1P service to ensure that health scores are within confidence levels using a combination of segmentation and benchmarking processes.

Cloud customers may rely on the cloud service to manage communication process flows and other processing tasks with consistency and predictability. Incidents, where customer(s) experience degraded performance and/or service unavailability, may occur infrequently. In such cases, the cloud service may proactively mitigate incidents and determine the underlying root causes in a timely manner (particularly for onboarding customers) to enhance the onboarding process. The techniques described herein may enable users to make effective decisions on when (and in which sector) to take action to stabilize system health for onboarding customers by utilizing correlated 1P signals while ensuring performance metrics of onboarding customers are satisfactory.

The benchmarking framework disclosed herein may be updated automatically based on various inputs and performance metrics, such as duration-based health scores and saturation-based health scores. Aspects of the present disclosure support using overall service health scores to identify similar customers with historic 1P signals and augment onboarding customer signals. The techniques described herein may also support using an iterative feedback loop with customer-level health score matrix validation between 3P and 1P to ensure that service health scores are within specified confidence levels. In some examples, segmentation and benchmarking can be used to identify a suitable pattern-matched customer set.

In the example of FIG. 3, the cloud service may begin onboarding the cloud client 105-f (a new customer) by identifying various attributes associated with the cloud client 105-f. For example, the cloud service may identify a type, a geographic region, a relative size (in terms of employees, customers, revenue, sales, or online interactions), and a send type associated with the cloud client 105-f (promotional or transactional). The cloud service may also determine whether the cloud client 105-f is to be onboarded to 1P or 3P. If the cloud client 105-f is onboarded to 1P, the cloud service may use 1P historic telemetry data (such as request volume, error metrics, average duration, and saturation data) for pattern matching 305. Accordingly, the cloud service may generate averaged benchmarks 310 for the cloud client 105-f, and may select one or more client systems for inclusion in a peer customer set 315 for the cloud client 105-f.

Alternatively, if the cloud client 105-f is onboarded to 3P, the cloud service may determine whether there is historic 3P telemetry data available for peer clients. If the cloud service does not have access to 3P telemetry data, the cloud service may use extrapolation and/or linear regression to predict 3P performance using historic 1P data. If the cloud service has access to less than 12 months of historic 3P data, the cloud service may use pattern matching 320 to generate a peer-based telemetric data set for the cloud client 105-f. Accordingly, the cloud service may generate averaged benchmark data 330 for the cloud client 105-f and select one or more client systems for inclusion in a peer customer set 335 for the cloud client 105-f.

Thereafter, the cloud service may use the averaged benchmark data 330 along with the resulting pattern-matched telemetry data set to compute a hardware gain score 340 for the cloud client 105-f. The cloud service may use the hardware gain score 340 to correlate 3P hardware performance with 1P hardware performance. At 345, the cloud service may import telemetry data from 1P and use the imported 1P telemetry data to finish onboarding the cloud client 105-f. Alternatively, if the cloud service has access to more than 12 months of historic 3P telemetry data, the cloud service may implement pattern matching 325 without importing historic 1P telemetry data.

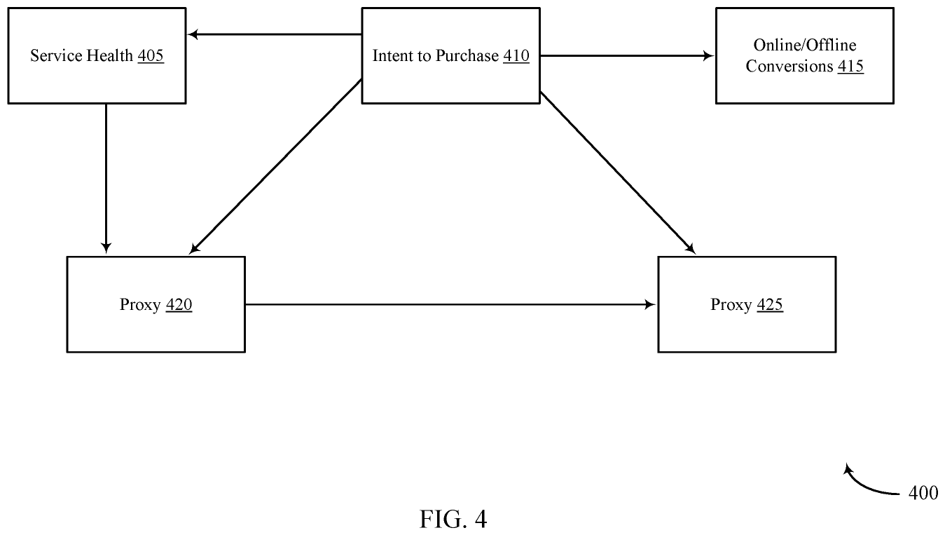

FIG. 4 illustrates an example of a proxy generation scheme 400 that supports using telemetry data to predict system performance in accordance with one or more aspects of the present disclosure. The proxy generation scheme 400 may implement or be implemented by aspects of any of the data processing systems or telemetry acquisition schemes described with reference to FIGS. 1 through 3. For example, the proxy generation scheme 400 may be implemented by one or more aspects of the cloud service 125-a, as described with reference to FIG. 2. The proxy generation scheme 400 may enable a cloud service to adjust and monitor overall performance (revenue, sales, conversions) of an onboarding customer using a combination of real-time telemetric data and service health data associated with a set of peer customers.

As described with reference to FIGS. 1 through 3, the techniques described herein may tie service health 405 to operational performance metrics (conversions, sales) using a proxy 425 like paid search clicks (brand or non-brand), volume-adjusted email clicks, etc. The telemetric prediction algorithms described herein may connect customer performance to service health 405 using causal inference. By identifying a proxy 425 for performance metrics (such as paid search clicks for conversions), causal inferences become more measurable. As an example, a proxy 420 for service health 405 may include a service health score for latency, which may be duration and/or saturation-based. Similarly, a proxy 425 for operational outcomes may leverage conversions and/or clicks. A proxy selection framework for identifying proxies for casual measurement may be represented mathematically using the following equations.

E(Online/Offline Conversions|(X=Healthy Service Health))−E(Online/Offline Conversions|(X=Unhealthy Service Health)) Equation 1: Average Causal Effect without Proxies

E(Online/Offline Conversions|(X=Healthy Service Health))−E(Online/Offline Conversions|(X=Unhealthy Service Health))=/=E(Online/Offline Conversions|(X=Latency Health Score less than 100%))−E(Online/Offline Conversions|(X=Latency Health Score greater than 100%)) Equation 2:Average Causal Impact with Proxies

The proxies described herein can be used to assess whether there was an adverse effect on onboarding customer conversions, adjusted based on peer-set synthetic control values of the same proxy signal (e.g., paid clicks). To ensure that service health 405 is correlated with overall performance, the cloud service may implement a two-step process where a peer set of customers are selected based on proxy service health score patterns (latency scores for duration and saturation). From this peer set, a subset based on matching proxies for performance metrics (e.g., paid search clicks, social media clicks) can be identified and used to establish a synthetic control. Accordingly, the cloud service may generate counterfactual predictions for the post-intervention period (assuming the intervention did occur) and leverage these counterfactual predictions to quantify the causal impact of the intervention. This causal impact can be compared against peers of the onboarding customer.

The proxy generation scheme 400 illustrates a causal inference model that predicts online/offline conversions 415 for onboarding customers prior to and after onboarding market matched to peer-based baseline signals and geographic regions to ensure that no negative impact occurred. Iterative improvements to the best-matched subset of customers may lead to identifying an optimal subset of customers to augment historical service health signals with the updated historical signals and additional historic information. The approach described herein involves market matching on service health proxies to identify synthetic control groups as well as to anonymize and randomly select from that group. A Bayesian causal inference model for outcome proxies (paid search clicks, brand clicks, revenue, conversions) of the customer prior to and after epochal marketing events may be compared to peer-based service health signals to ensure there was no negative impact. The proxy 420 (SLA-based latency health score) and the proxy 425 (paid click volume, paid brand clicks, email clicks) may be reliable, logical, leading indicators that are measurable and accessible to the cloud service.

In some examples, the cloud service may use artificial intelligence (AI) to iteratively improve onboarding customer systems and enhance overall customer health. The cloud service can measure and concurrently improve service health performance for the onboarding customers across multiple send types using causal Bayesian inference on customer responses (such as conversions and revenue). The cloud service may also use Bayesian market matching causal inferences to assess and prioritize impact to customer outcome measures due to changes compared to similar causal inferences for customers in multiple quasi-control groups to ensure consistent and substantive impact using multiple comparison sets. In some examples, the onboarding customer may be comparatively market matched against a quasi-control group. In other example, the onboarding customer may be comparatively market matched in a quasi-control group that is determined according to the day of the week. Additionally, or alternatively, the onboarding customer may be comparatively market matched in a quasi-control group that is determined according to the week of the year.

The cloud service may periodically re-assess signal augmentation options from the service health score pattern-matched peer set based on service health adjustments. Secondary measures that impact service health 405 may also be adjusted. For example, the cloud service may decrease message complexity if service health 405 is poor. Similarly, mail transfer agents (which deliver marketing messages to Internet Service Providers (ISP) for inbox delivery) may be adjusted to prioritize high fidelity sends and improve service health 405. The cloud service may predict or otherwise quantify intent to purchase 410 using the various proxies described herein (such as the proxy 420 and/or the proxy 425). The intent to purchase 410 may directly affect online/offline conversions 415 as well as service health 405.

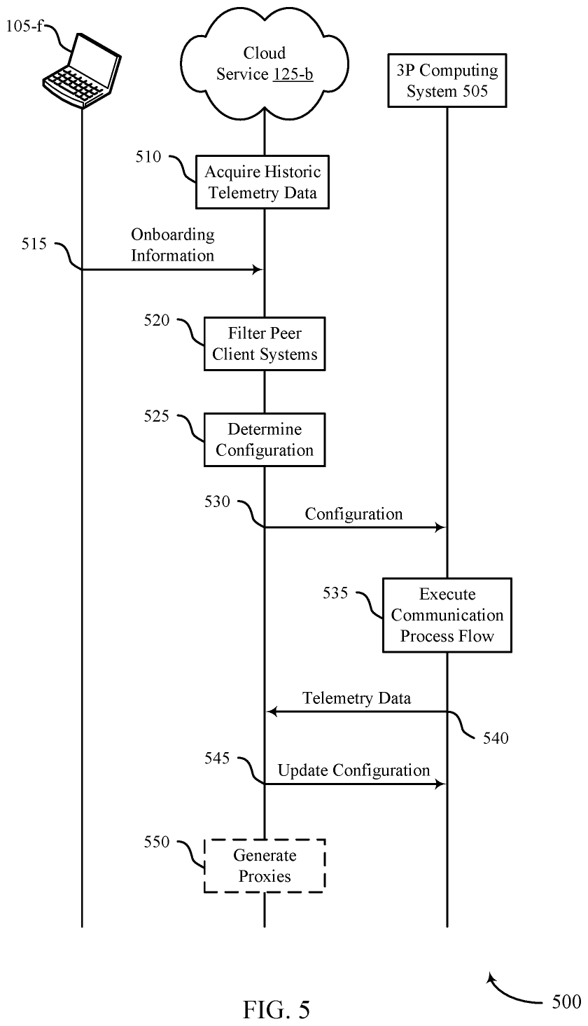

FIG. 5 illustrates an example of a process flow 500 that supports using telemetry data to predict system performance in accordance with one or more aspects of the present disclosure. The process flow 500 may implement or be implemented by aspects of any of the data processing systems, telemetry acquisition schemes, or proxy generation schemes described with reference to FIGS. 1 through 4. For example, the process flow 500 includes a cloud client 105-f, a cloud service 125-b, and a 3P computing system 505, which may be examples of corresponding elements described herein. In the following description of the process flow 500, operations between the cloud client 105-f, the cloud service 125-b, and the 3P computing system 505 may be added, omitted, or performed in a different order (with respect to the exemplary order shown).

At 510, the cloud service 125-b may acquire historic telemetry data for various 1P client systems by executing and monitoring communication process flows (such as the communication process flow 225 described with reference to FIG. 2) that control electronic communications between the 1P systems and users associated with the 1P systems (for example, the contacts 110 described with reference to FIG. 1). The telemetry data may include request volume information, error metrics, latency metrics, request saturation data, and other KPIs.

At 515, the cloud service 125-b may receive onboarding information that pertains to the cloud client 105-f. The onboarding information may include one or more attributes associated with the cloud client 105-f, such as a geographic location of the cloud client 105-f, a relative size of the cloud client 105-f, an operational category or classification associated with the cloud client 105-f, a quantity of users associated with the cloud client 105-f, or a combination thereof.

At 520, the cloud service 125-b may filter the various 1P client systems to identify a set of one or more 1P client systems having attributes that satisfy a threshold with respect to the attributes of the cloud client 105-f. In some examples, filtering the 1P client systems may include identifying the set of one or more client systems by using an iterative weighted averaging function to filter the 1P client systems according to the historic telemetry data.

At 525, the cloud service 125-b may determine a configuration for the cloud client 105-f based on historic 1P telemetry data associated with the identified set of 1P client systems. The configuration may include a hardware SKU, a software configuration, a quantity of processing resources, a server location, a workload distribution, etc. In some examples, the cloud service 125-b may generate 3P telemetry benchmarks for the cloud client 105-f based on the historic 1P data associated with the identified set of 1P client systems, and may determine a configuration for the cloud client 105-f based on the 3P telemetry benchmarks. More specifically, the cloud service 125-b may transform the historic 1P telemetry data associated with the identified set of 1P client systems into projected 3P baseline telemetry data for the cloud client 105-f, and may derive the 3P telemetry benchmarks from the projected 3P baseline telemetry data.

At 530, the cloud service 125-b may transmit an indication of the configuration to the 3P computing system 505. At 535, the cloud service 125-b may execute a communication process flow that controls electronic communications between the cloud client 105-f and two or more users associated with the cloud client 105-f. The cloud service 125-b may execute the communication process flow using 1P processing resources hosted by the cloud service 125-b and/or 3P processing resources provided by the 3P computing system 505. The cloud service 125-b may execute the communication process flow in accordance with the configuration determined at 525.

At 540, the cloud service 125-b may receive real-time telemetry data associated with the communication process flow, and may store both the real-time telemetry data and the historic 1P telemetry data in a data store that is inaccessible to the 3P computing system 505 (such as the data center 120 described with reference to FIG. 1). At 545, the cloud service 125-b may (in some examples) update the configuration of the cloud client 105-f based on the telemetry data received from the 3P computing system 505. For example, the cloud service 125-b may adjust one or more parameters of the communication process flow (such as email complexity) to improve the performance of the communication process flow.

Additionally, or alternatively, the cloud service 125-b may add or remove at least one client system from the identified set of one or more client systems based on the real-time telemetry data associated with the communication process flow. The cloud service 125-b may also generate a performance score (equivalently referred to herein as a service health score) for the cloud client 105-f and a confidence interval associated the performance score based on performing one or more matrix validation operations, segmentation procedures, and benchmarking processes on the telemetry data obtained from the 3P computing system 505.

At 550, the cloud service 125-b may optionally generate one or more performance-related proxy values associated with the cloud client 105-f. The cloud service 125-b may generate the performance-related proxy values based on real-time telemetry data associated with the communication process flow. Accordingly, the cloud service 125-b may use the performance-related proxy values to determine whether the configuration of the cloud client 105-f adversely affected an outcome of the communication process flow (for example, by comparing the proxy values to corresponding proxy values associated with the identified set of 1P client systems).

Aspects of the process flow 500 may be implemented to realize one or more of the following advantages. The techniques described with reference to FIG. 5 may enable the cloud service 125-b to predict telemetry benchmarks and baseline performance metrics for the cloud client 105-f (an onboarding client system) based on historic telemetry data associated with similar client systems. For example, the cloud service 125-b may extrapolate and/or transform telemetry data associated with a peer client system to determine a set of baseline metrics to use for evaluating the performance of processing tasks associated with the cloud client 105-f. Likewise, the cloud service 125-b may use 1P telemetry data to determine a suitable type and/or quantity of 3P hardware resources to allocate for the cloud client 105-f, which may improve the performance of communication process flows and other processing tasks associated with the cloud client 105-f, among other benefits.

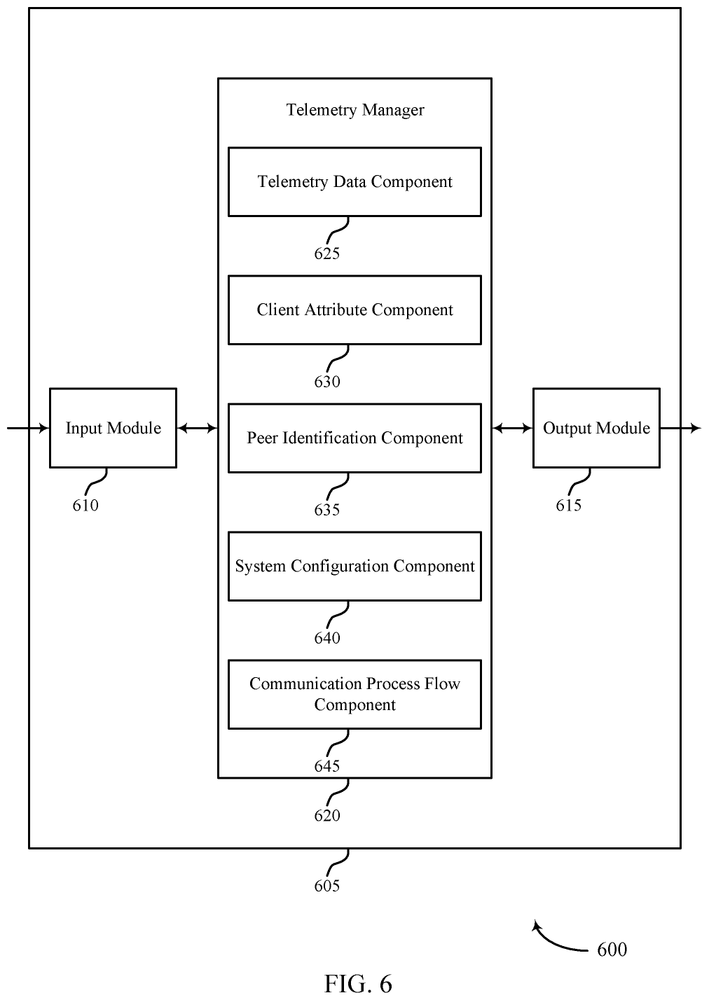

FIG. 6 illustrates a block diagram 600 of a device 605 that supports using telemetry data to predict system performance in accordance with one or more aspects of the present disclosure. The device 605 may include an input module 610, an output module 615, and a telemetry manager 620. The device 605 may also include a processor. Each of these components may be in communication with one another (e.g., via one or more buses).

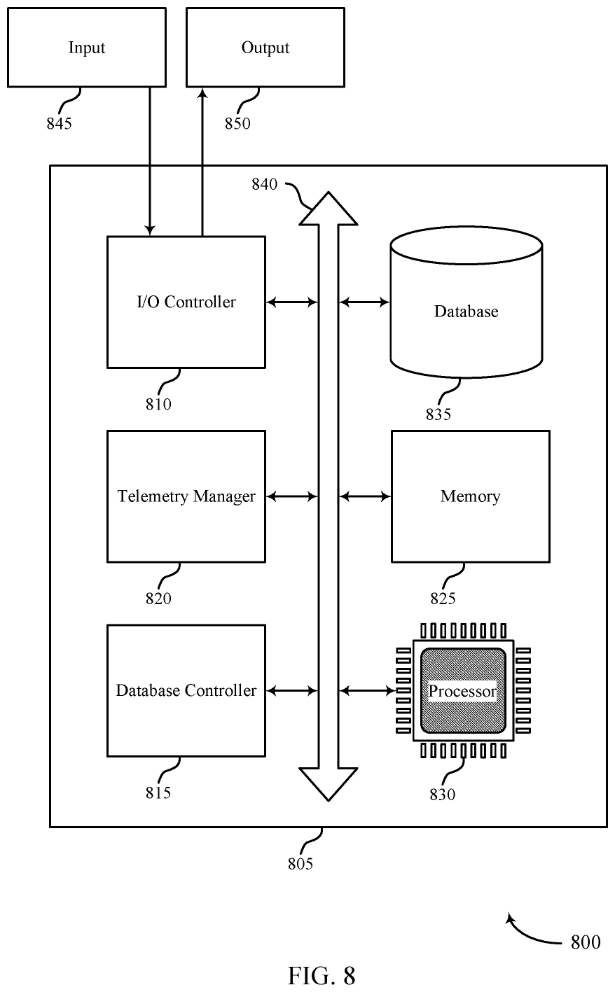

The input module 610 may manage input signals for the device 605. For example, the input module 610 may identify input signals based on an interaction with a modem, a keyboard, a mouse, a touchscreen, or a similar device. These input signals may be associated with user input or processing at other components or devices. In some cases, the input module 610 may utilize an operating system such as iOS®, ANDROID®, MS-DOS®, MS-WINDOWS®, OS/2®, UNIX®, LINUX®, or another known operating system to handle input signals. The input module 610 may send aspects of these input signals to other components of the device 605 for processing. For example, the input module 610 may transmit input signals to the telemetry manager 620 to support using telemetry data to predict system performance. In some cases, the input module 610 may be a component of an input/output (I/O) controller 810 as described with reference to FIG. 8.

The output module 615 may manage output signals for the device 605. For example, the output module 615 may receive signals from other components of the device 605, such as the telemetry manager 620, and may transmit these signals to other components or devices. In some examples, the output module 615 may transmit output signals for display in a user interface, for storage in a database or data store, for further processing at a server or server cluster, or for any other processes at any number of devices or systems. In some cases, the output module 615 may be a component of an I/O controller 810 as described with reference to FIG. 8.

For example, the telemetry manager 620 may include a telemetry data component 625, a client attribute component 630, a peer identification component 635, a system configuration component 640, a communication process flow component 645, or any combination thereof. In some examples, the telemetry manager 620, or various components thereof, may be configured to perform various operations (e.g., receiving, monitoring, transmitting) using or otherwise in cooperation with the input module 610, the output module 615, or both. For example, the telemetry manager 620 may receive information from the input module 610, send information to the output module 615, or be integrated in combination with the input module 610, the output module 615, or both to receive information, transmit information, or perform various other operations as described herein.

The telemetry manager 620 may support data processing in accordance with examples disclosed herein. The telemetry data component 625 may be configured to support acquiring telemetry data for multiple client systems supported by a cloud service that controls electronic communications between the multiple client systems and multiple users associated with the multiple client systems. The client attribute component 630 may be configured to support receiving an indication of one or more attributes associated with a first client system supported by the cloud service. The peer identification component 635 may be configured to support filtering the multiple client systems to identify a set of one or more client systems having attributes that satisfy a similarity threshold with respect to the one or more attributes associated with the first client system. The system configuration component 640 may be configured to support determining a configuration for the first client system based on the telemetry data associated with the set of one or more client systems. The communication process flow component 645 may be configured to support executing at least one communication process flow that controls electronic communications between the first client system and two or more users associated with the first client system in accordance with the configuration. The telemetry data component 625 may be configured to support obtaining telemetry data for the first client system based on executing the at least one communication process flow in accordance with the configuration.

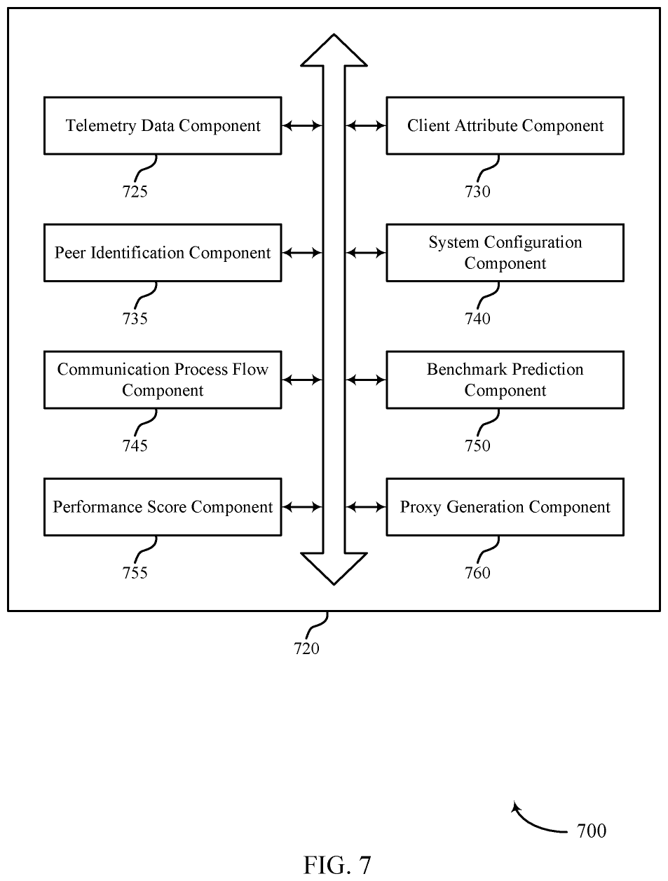

FIG. 7 illustrates a block diagram 700 of a telemetry manager 720 that supports using telemetry data to predict system performance in accordance with one or more aspects of the present disclosure. The telemetry manager 720 may be an example of aspects of a telemetry manager or a telemetry manager 620, or both, as described herein. The telemetry manager 720, or various components thereof, may be an example of means for performing various aspects of using telemetry data to predict system performance as described herein. For example, the telemetry manager 720 may include a telemetry data component 725, a client attribute component 730, a peer identification component 735, a system configuration component 740, a communication process flow component 745, a benchmark prediction component 750, a performance score component 755, a proxy generation component 760, or any combination thereof. Each of these components may communicate, directly or indirectly, with one another (e.g., via one or more buses).

The telemetry manager 720 may support data processing in accordance with examples disclosed herein. The telemetry data component 725 may be configured to support acquiring telemetry data for multiple client systems supported by a cloud service that controls electronic communications between the multiple client systems and multiple users associated with the multiple client systems. The client attribute component 730 may be configured to support receiving an indication of one or more attributes associated with a first client system supported by the cloud service. The peer identification component 735 may be configured to support filtering the multiple client systems to identify a set of one or more client systems having attributes that satisfy a similarity threshold with respect to the one or more attributes associated with the first client system. The system configuration component 740 may be configured to support determining a configuration for the first client system based on the telemetry data associated with the set of one or more client systems. The communication process flow component 745 may be configured to support executing at least one communication process flow that controls electronic communications between the first client system and two or more users associated with the first client system in accordance with the configuration. In some examples, the telemetry data component 725 may be configured to support obtaining telemetry data for the first client system based on executing the at least one communication process flow in accordance with the configuration.

In some examples, the benchmark prediction component 750 may be configured to support generating 3P telemetry benchmarks for the first client system based on 1P telemetry data associated with the set of one or more client systems, where the 3P telemetry benchmarks are used to determine the configuration for the first client system.

In some examples, the telemetry data component 725 may be configured to support transforming the 1P telemetry data associated with the set of one or more client systems into projected 3P baseline data for the first client system, where the 3P telemetry benchmarks are derived from the projected 3P baseline data.

In some examples, the system configuration component 740 may be configured to support updating the configuration of the first client system according to the telemetry data obtained from executing the at least one communication process flow.

In some examples, the peer identification component 735 may be configured to support removing at least one client system from the set of one or more client systems based on the telemetry data obtained from executing the at least one communication process flow.

In some examples, the peer identification component 735 may be configured to support adding at least one client system to the set of one or more client systems based on the telemetry data obtained from executing the at least one communication process flow.

In some examples, the performance score component 755 may be configured to support generating a performance score for the first client system and a confidence interval associated with the performance score based on performing one or more matrix validation operations, segmentation procedures, and benchmarking processes on the telemetry data obtained from executing the at least one communication process flow.

In some examples, the system configuration component 740 may be configured to support adjusting one or more parameters of the at least one communication process flow to increase the performance score of the first client system.

In some examples, to support filtering the multiple client systems, the peer identification component 735 may be configured to support identifying the set of one or more client systems based on using an iterative weighted averaging function to filter the multiple client systems according to the telemetry data.

In some examples, the proxy generation component 760 may be configured to support generating one or more proxy values that correspond to performance metrics associated with the first client system, where the one or more proxy values are based on the telemetry data obtained from executing the at least one communication process flow.

In some examples, the system configuration component 740 may be configured to support determining whether the configuration of the first client system affected an outcome of the at least one communication process flow based on comparing the one or more proxy values to corresponding proxy values associated with the set of one or more client systems.

In some examples, the telemetry data component 725 may be configured to support storing the telemetry data in a 1P computing environment that is inaccessible to 3P cloud service providers.

In some examples, the peer identification component 735 may be configured to support updating the set of one or more client systems by iteratively comparing the telemetry data obtained from the at least one communication process flow to historic telemetry data obtained from communication process flows associated with the set of one or more client systems.

In some examples, the set of one or more client systems are hosted in a 1P computing environment supported by the cloud service. In some examples, the first client system is hosted in a 3P computing environment supported by an external cloud service provider.

In some examples, the at least one communication process flow is executed using compute resources provided by the cloud service or compute resources provided by a 3P cloud service provider. In some examples, the one or more attributes include a geographic location of the first client system, a size of the first client system, a category of the first client system, a quantity of customers associated with the first client system, or a combination thereof.

In some examples, the telemetry data includes request volume information, error metrics, timing information, request saturation data, or a combination thereof. In some examples, the configuration includes a hardware configuration, a software configuration, a quantity of compute resources, a geographic distribution of compute resources, or a combination thereof.

FIG. 8 illustrates a diagram of a system 800 including a system 805 that supports using telemetry data to predict system performance in accordance with one or more aspects of the present disclosure. The system 805 may be an example of or include the components of a device 605 as described herein. The system 805 may include components for bi-directional data communications including components for transmitting and receiving communications, such as a telemetry manager 820, an I/O controller 810, a database controller 815, a memory 825, a processor 830, and a database 835. These components may be in electronic communication or otherwise coupled (e.g., operatively, communicatively, functionally, electronically, electrically) via one or more buses (e.g., a bus 840).

The I/O controller 810 may manage input signals 845 and output signals 850 for the system 805. The I/O controller 810 may also manage peripherals not integrated into the system 805. In some cases, the I/O controller 810 may represent a physical connection or port to an external peripheral. In some cases, the I/O controller 810 may utilize an operating system such as iOS®, ANDROID®, MS-DOS®, MS-WINDOWS®, OS/2®, UNIX®, LINUX®, or another known operating system. In other cases, the I/O controller 810 may represent or interact with a modem, a keyboard, a mouse, a touchscreen, or a similar device. In some cases, the I/O controller 810 may be implemented as part of a processor 830. In some examples, a user may interact with the system 805 via the I/O controller 810 or via hardware components controlled by the I/O controller 810.

The database controller 815 may manage data storage and processing in a database 835. In some cases, a user may interact with the database controller 815. In other cases, the database controller 815 may operate automatically without user interaction. The database 835 may be an example of a single database, a distributed database, multiple distributed databases, a data store, a data lake, or an emergency backup database.

Memory 825 may include random-access memory (RAM) and read-only memory (ROM). The memory 825 may store computer-readable, computer-executable software including instructions that, when executed, cause the processor 830 to perform various functions described herein. In some cases, the memory 825 may contain, among other things, a basic I/O system (BIOS) which may control basic hardware or software operation such as the interaction with peripheral components or devices.

The processor 830 may include an intelligent hardware device, (e.g., a general-purpose processor, a digital signal processor (DSP), a central processing unit (CPU), a microcontroller, an application-specific integrated circuit (ASIC), a field-programmable gate array (FPGA), a programmable logic device, a discrete gate or transistor logic component, a discrete hardware component, or any combination thereof). In some cases, the processor 830 may be configured to operate a memory array using a memory controller. In other cases, a memory controller may be integrated into the processor 830. The processor 830 may be configured to execute computer-readable instructions stored in a memory 825 to perform various functions (e.g., functions or tasks supporting using telemetry data to predict system performance).

The telemetry manager 820 may support data processing in accordance with examples disclosed herein. For example, the telemetry manager 820 may be configured to support acquiring telemetry data for multiple client systems supported by a cloud service that controls electronic communications between the multiple client systems and multiple users associated with the multiple client systems. The telemetry manager 820 may be configured to support receiving an indication of one or more attributes associated with a first client system supported by the cloud service. The telemetry manager 820 may be configured to support filtering the multiple client systems to identify a set of one or more client systems having attributes that satisfy a similarity threshold with respect to the one or more attributes associated with the first client system. The telemetry manager 820 may be configured to support determining a configuration for the first client system based on the telemetry data associated with the set of one or more client systems. The telemetry manager 820 may be configured to support executing at least one communication process flow that controls electronic communications between the first client system and two or more users associated with the first client system in accordance with the configuration. The telemetry manager 820 may be configured to support obtaining telemetry data for the first client system based on executing the at least one communication process flow in accordance with the configuration.

By including or configuring the telemetry manager 820 in accordance with examples as described herein, the system 805 may support techniques for reduced latency, improved performance, and greater processing efficiency by enabling a cloud service (such as the cloud service 125-a described with reference to FIG. 2) to predict telemetry benchmarks and baseline performance metrics for onboarding client systems based on historic telemetry data associated with peer client systems. For example, the cloud service may extrapolate and/or transform telemetry data associated with a peer client system to determine a set of baseline metrics to use for evaluating the performance of processing tasks associated with the onboarding client system. Likewise, the cloud service may use 1P telemetry data to determine a suitable type and/or quantity of 3P hardware resources to allocate for the onboarding client system, which may improve the performance of communication process flows and other processing tasks associated with the onboarding client system.

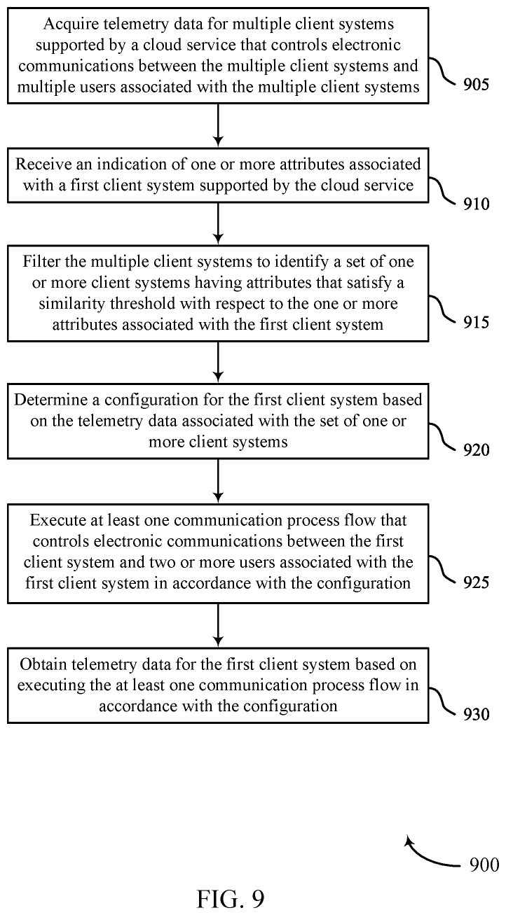

FIG. 9 illustrates a flowchart showing a method 900 that supports using telemetry data to predict system performance in accordance with one or more aspects of the present disclosure. The operations of the method 900 may be implemented by a data processing system or components thereof. For example, the operations of the method 900 may be performed by one or more aspects of the data processing system 200 described with reference to FIG. 2. In some examples, the data processing system may execute a set of instructions to control functional elements of the data processing system to perform the described functions. Additionally, or alternatively, the data processing system may perform aspects of the described functions using special-purpose hardware.

At 905, the data processing system may acquire telemetry data for multiple client systems supported by a cloud service that controls electronic communications between the multiple client systems and multiple users associated with the multiple client systems. The operations of 905 may be performed in accordance with examples disclosed herein. In some examples, aspects of the operations of 905 may be performed by a telemetry data component 725, as described with reference to FIG. 7.

At 910, the data processing system may receive an indication of one or more attributes associated with a first client system supported by the cloud service. The operations of 910 may be performed in accordance with examples disclosed herein. In some examples, aspects of the operations of 910 may be performed by a client attribute component 730, as described with reference to FIG. 7.

At 915, the data processing system may filter the multiple client systems to identify a set of one or more client systems having attributes that satisfy a similarity threshold with respect to the one or more attributes associated with the first client system. The operations of 915 may be performed in accordance with examples disclosed herein. In some examples, aspects of the operations of 915 may be performed by a peer identification component 735, as described with reference to FIG. 7.

At 920, the data processing system may determine a configuration for the first client system based on the telemetry data associated with the set of one or more client systems. The operations of 920 may be performed in accordance with examples disclosed herein. In some examples, aspects of the operations of 920 may be performed by a system configuration component 740, as described with reference to FIG. 7.

At 925, the data processing system may execute at least one communication process flow that controls electronic communications between the first client system and two or more users associated with the first client system in accordance with the configuration. The operations of 925 may be performed in accordance with examples disclosed herein. In some examples, aspects of the operations of 925 may be performed by a communication process flow component 745, as described with reference to FIG. 7.

At 930, the data processing system may obtain telemetry data for the first client system based on executing the at least one communication process flow in accordance with the configuration. The operations of 930 may be performed in accordance with examples disclosed herein. In some examples, aspects of the operations of 930 may be performed by a telemetry data component 725, as described with reference to FIG. 7.

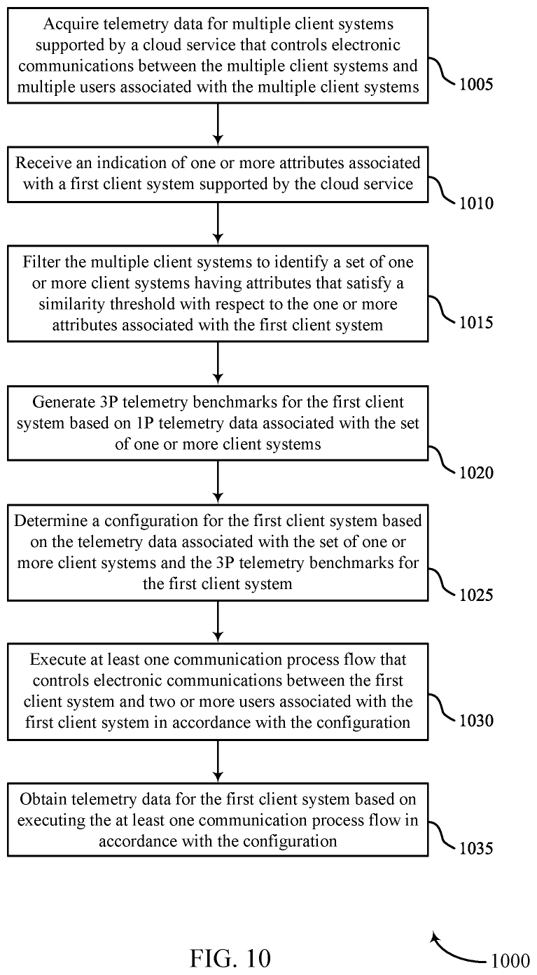

FIG. 10 illustrates a flowchart showing a method 1000 that supports using telemetry data to predict system performance in accordance with one or more aspects of the present disclosure. The operations of the method 1000 may be implemented by a data processing system or components thereof. For example, the operations of the method 1000 may be performed by one or more aspects of the data processing system 100 described with reference to FIG. 1. In some examples, the data processing system may execute a set of instructions to control functional elements of the data processing system to perform the described functions. Additionally, or alternatively, the data processing system may perform aspects of the described functions using special-purpose hardware.

At 1005, the data processing system may acquire telemetry data for multiple client systems supported by a cloud service that controls electronic communications between the multiple client systems and multiple users associated with the multiple client systems. The operations of 1005 may be performed in accordance with examples disclosed herein. In some examples, aspects of the operations of 1005 may be performed by a telemetry data component 725, as described with reference to FIG. 7.

At 1010, the data processing system may receive an indication of one or more attributes associated with a first client system supported by the cloud service. The operations of 1010 may be performed in accordance with examples disclosed herein. In some examples, aspects of the operations of 1010 may be performed by a client attribute component 730, as described with reference to FIG. 7.

At 1015, the data processing system may filter the multiple client systems to identify a set of one or more client systems having attributes that satisfy a similarity threshold with respect to the one or more attributes associated with the first client system. The operations of 1015 may be performed in accordance with examples disclosed herein. In some examples, aspects of the operations of 1015 may be performed by a peer identification component 735, as described with reference to FIG. 7.

At 1020, the data processing system may generate 3P telemetry benchmarks for the first client system based on 1P telemetry data associated with the set of one or more client systems. The operations of 1020 may be performed in accordance with examples disclosed herein. In some examples, aspects of the operations of 1020 may be performed by a benchmark prediction component 750, as described with reference to FIG. 7.

At 1025, the data processing system may determine a configuration for the first client system based on the telemetry data associated with the set of one or more client systems and the 3P telemetry benchmarks for the first client system. The operations of 1025 may be performed in accordance with examples disclosed herein. In some examples, aspects of the operations of 1025 may be performed by a system configuration component 740, as described with reference to FIG. 7.

At 1030, the data processing system may execute at least one communication process flow that controls electronic communications between the first client system and two or more users associated with the first client system in accordance with the configuration. The operations of 1030 may be performed in accordance with examples disclosed herein. In some examples, aspects of the operations of 1030 may be performed by a communication process flow component 745, as described with reference to FIG. 7.

At 1035, the data processing system may obtain telemetry data for the first client system based on executing the at least one communication process flow in accordance with the configuration. The operations of 1035 may be performed in accordance with examples disclosed herein. In some examples, aspects of the operations of 1035 may be performed by a telemetry data component 725, as described with reference to FIG. 7.

A method for data processing is described. The method may include acquiring telemetry data for multiple client systems supported by a cloud service that controls electronic communications between the multiple client systems and multiple users associated with the multiple client systems. The method may further include receiving an indication of one or more attributes associated with a first client system supported by the cloud service. The method may further include filtering the multiple client systems to identify a set of one or more client systems having attributes that satisfy a similarity threshold with respect to the one or more attributes associated with the first client system. The method may further include determining a configuration for the first client system based on the telemetry data associated with the set of one or more client systems. The method may further include executing at least one communication process flow that controls electronic communications between the first client system and two or more users associated with the first client system in accordance with the configuration. The method may further include obtaining telemetry data for the first client system based on executing the at least one communication process flow in accordance with the configuration.

An apparatus for data processing is described. The apparatus may include a processor, memory coupled with the processor, and instructions stored in the memory. The instructions may be executable by the processor to cause the apparatus to acquire telemetry data for multiple client systems supported by a cloud service that controls electronic communications between the multiple client systems and multiple users associated with the multiple client systems. The instructions may be further executable by the processor to cause the apparatus to receive an indication of one or more attributes associated with a first client system supported by the cloud service. The instructions may be further executable by the processor to cause the apparatus to filter the multiple client systems to identify a set of one or more client systems having attributes that satisfy a similarity threshold with respect to the one or more attributes associated with the first client system. The instructions may be further executable by the processor to cause the apparatus to determine a configuration for the first client system based on the telemetry data associated with the set of one or more client systems. The instructions may be further executable by the processor to cause the apparatus to execute at least one communication process flow that controls electronic communications between the first client system and two or more users associated with the first client system in accordance with the configuration. The instructions may be further executable by the processor to cause the apparatus to obtain telemetry data for the first client system based on executing the at least one communication process flow in accordance with the configuration.

Another apparatus for data processing is described. The apparatus may include means for acquiring telemetry data for multiple client systems supported by a cloud service that controls electronic communications between the multiple client systems and multiple users associated with the multiple client systems. The apparatus may further include means for receiving an indication of one or more attributes associated with a first client system supported by the cloud service. The apparatus may further include means for filtering the multiple client systems to identify a set of one or more client systems having attributes that satisfy a similarity threshold with respect to the one or more attributes associated with the first client system. The apparatus may further include means for determining a configuration for the first client system based on the telemetry data associated with the set of one or more client systems. The apparatus may further include means for executing at least one communication process flow that controls electronic communications between the first client system and two or more users associated with the first client system in accordance with the configuration. The apparatus may further include means for obtaining telemetry data for the first client system based on executing the at least one communication process flow in accordance with the configuration.

A non-transitory computer-readable medium storing code for data processing is described. The code may include instructions executable by a processor to acquire telemetry data for multiple client systems supported by a cloud service that controls electronic communications between the multiple client systems and multiple users associated with the multiple client systems. The instructions may be further executable by the processor to receive an indication of one or more attributes associated with a first client system supported by the cloud service. The instructions may be further executable by the processor to filter the multiple client systems to identify a set of one or more client systems having attributes that satisfy a similarity threshold with respect to the one or more attributes associated with the first client system. The instructions may be further executable by the processor to determine a configuration for the first client system based on the telemetry data associated with the set of one or more client systems. The instructions may be further executable by the processor to execute at least one communication process flow that controls electronic communications between the first client system and two or more users associated with the first client system in accordance with the configuration. The instructions may be further executable by the processor to obtain telemetry data for the first client system based on executing the at least one communication process flow in accordance with the configuration.

Some examples of the methods, apparatuses, and non-transitory computer-readable media described herein may further include operations, features, means, or instructions for generating 3P telemetry benchmarks for the first client system based on 1P telemetry data associated with the set of one or more client systems, where the 3P telemetry benchmarks may be used to determine the configuration for the first client system.

Some examples of the methods, apparatuses, and non-transitory computer-readable media described herein may further include operations, features, means, or instructions for transforming the 1P telemetry data associated with the set of one or more client systems into projected 3P baseline data for the first client system, where the 3P telemetry benchmarks may be derived from the projected 3P baseline data.

Some examples of the methods, apparatuses, and non-transitory computer-readable media described herein may further include operations, features, means, or instructions for updating the configuration of the first client system according to the telemetry data obtained from executing the at least one communication process flow.

Some examples of the methods, apparatuses, and non-transitory computer-readable media described herein may further include operations, features, means, or instructions for removing at least one client system from the set of one or more client systems based on the telemetry data obtained from executing the at least one communication process flow.

Some examples of the methods, apparatuses, and non-transitory computer-readable media described herein may further include operations, features, means, or instructions for adding at least one client system to the set of one or more client systems based on the telemetry data obtained from executing the at least one communication process flow.

Some examples of the methods, apparatuses, and non-transitory computer-readable media described herein may further include operations, features, means, or instructions for generating a performance score for the first client system and a confidence interval associated with the performance score based on performing one or more matrix validation operations, segmentation procedures, and benchmarking processes on the telemetry data obtained from executing the at least one communication process flow.

Some examples of the methods, apparatuses, and non-transitory computer-readable media described herein may further include operations, features, means, or instructions for adjusting one or more parameters of the at least one communication process flow to increase the performance score of the first client system.

In some examples of the methods, apparatuses, and non-transitory computer-readable media described herein, filtering the multiple client systems may include operations, features, means, or instructions for identifying the set of one or more client systems based on using an iterative weighted averaging function to filter the multiple client systems according to the telemetry data.

Some examples of the methods, apparatuses, and non-transitory computer-readable media described herein may further include operations, features, means, or instructions for generating one or more proxy values that correspond to performance metrics associated with the first client system, where the one or more proxy values may be based on the telemetry data obtained from executing the at least one communication process flow.

Some examples of the methods, apparatuses, and non-transitory computer-readable media described herein may further include operations, features, means, or instructions for determining whether the configuration of the first client system affected an outcome of the at least one communication process flow based on comparing the one or more proxy values to corresponding proxy values associated with the set of one or more client systems.

Some examples of the methods, apparatuses, and non-transitory computer-readable media described herein may further include operations, features, means, or instructions for storing the telemetry data in a 1P computing environment that is inaccessible to 3P cloud service providers.

Some examples of the methods, apparatuses, and non-transitory computer-readable media described herein may further include operations, features, means, or instructions for updating the set of one or more client systems by iteratively comparing the telemetry data obtained from the at least one communication process flow to historic telemetry data obtained from communication process flows associated with the set of one or more client systems.

In some examples of the methods, apparatuses, and non-transitory computer-readable media described herein, the set of one or more client systems may be hosted in a 1P computing environment supported by the cloud service, and the first client system may be hosted in a 3P computing environment supported by an external cloud service provider.

In some examples of the methods, apparatuses, and non-transitory computer-readable media described herein, the at least one communication process flow may be executed using compute resources provided by the cloud service or compute resources provided by a 3P cloud service provider.

In some examples of the methods, apparatuses, and non-transitory computer-readable media described herein, the one or more attributes include a geographic location of the first client system, a size of the first client system, a category of the first client system, a quantity of customers associated with the first client system, or a combination thereof.

In some examples of the methods, apparatuses, and non-transitory computer-readable media described herein, the telemetry data includes request volume information, error metrics, timing information, request saturation data, or a combination thereof.

In some examples of the methods, apparatuses, and non-transitory computer-readable media described herein, the configuration includes a hardware configuration, a software configuration, a quantity of compute resources, a geographic distribution of compute resources, or a combination thereof.

The following provides an overview of aspects of the present disclosure:

Aspect 1: A method for data processing, comprising: acquiring telemetry data for a plurality of client systems supported by a cloud service that controls electronic communications between the plurality of client systems and a plurality of users associated with the plurality of client systems; receiving an indication of one or more attributes associated with a first client system supported by the cloud service; filtering the plurality of client systems to identify a set of one or more client systems having attributes that satisfy a similarity threshold with respect to the one or more attributes associated with the first client system; determining a configuration for the first client system based at least in part on the telemetry data associated with the set of one or more client systems; executing at least one communication process flow that controls electronic communications between the first client system and two or more users associated with the first client system in accordance with the configuration; and obtaining telemetry data for the first client system based at least in part on executing the at least one communication process flow in accordance with the configuration.

Aspect 2: The method of aspect 1, further comprising: generating third-party telemetry benchmarks for the first client system based at least in part on first-party telemetry data associated with the set of one or more client systems, wherein the third-party telemetry benchmarks are used to determine the configuration for the first client system.

Aspect 3: The method of aspect 2, further comprising: transforming the first-party telemetry data associated with the set of one or more client systems into projected third-party baseline data for the first client system, wherein the third-party telemetry benchmarks are derived from the projected third-party baseline data.

Aspect 4: The method of any of aspects 1 through 3, further comprising: updating the configuration of the first client system according to the telemetry data obtained from executing the at least one communication process flow.

Aspect 5: The method of any of aspects 1 through 4, further comprising: removing at least one client system from the set of one or more client systems based at least in part on the telemetry data obtained from executing the at least one communication process flow.

Aspect 6: The method of any of aspects 1 through 5, further comprising: adding at least one client system to the set of one or more client systems based at least in part on the telemetry data obtained from executing the at least one communication process flow.

Aspect 7: The method of any of aspects 1 through 6, further comprising: generating a performance score for the first client system and a confidence interval associated with the performance score based at least in part on performing one or more matrix validation operations, segmentation procedures, and benchmarking processes on the telemetry data obtained from executing the at least one communication process flow.

Aspect 8: The method of aspect 7, further comprising: adjusting one or more parameters of the at least one communication process flow to increase the performance score of the first client system.

Aspect 9: The method of any of aspects 1 through 8, wherein filtering the plurality of client systems comprises: identifying the set of one or more client systems based at least in part on using an iterative weighted averaging function to filter the plurality of client systems according to the telemetry data.

Aspect 10: The method of any of aspects 1 through 9, further comprising: generating one or more proxy values that correspond to performance metrics associated with the first client system, wherein the one or more proxy values are based at least in part on the telemetry data obtained from executing the at least one communication process flow.

Aspect 11: The method of aspect 10, further comprising: determining whether the configuration of the first client system affected an outcome of the at least one communication process flow based at least in part on comparing the one or more proxy values to corresponding proxy values associated with the set of one or more client systems.

Aspect 12: The method of any of aspects 1 through 11, further comprising: storing the telemetry data in a first-party computing environment that is inaccessible to third-party cloud service providers.

Aspect 13: The method of any of aspects 1 through 12, further comprising: updating the set of one or more client systems by iteratively comparing the telemetry data obtained from the at least one communication process flow to historic telemetry data obtained from communication process flows associated with the set of one or more client systems.

Aspect 14: The method of any of aspects 1 through 13, wherein the set of one or more client systems are hosted in a first-party computing environment supported by the cloud service; and the first client system is hosted in a third-party computing environment supported by an external cloud service provider.

Aspect 15: The method of any of aspects 1 through 14, wherein the at least one communication process flow is executed using compute resources provided by the cloud service or compute resources provided by a third-party cloud service provider.

Aspect 16: The method of any of aspects 1 through 15, wherein the one or more attributes comprise a geographic location of the first client system, a size of the first client system, a category of the first client system, a quantity of customers associated with the first client system, or a combination thereof.

Aspect 17: The method of any of aspects 1 through 16, wherein the telemetry data comprises request volume information, error metrics, timing information, request saturation data, or a combination thereof.

Aspect 18: The method of any of aspects 1 through 17, wherein the configuration comprises a hardware configuration, a software configuration, a quantity of compute resources, a geographic distribution of compute resources, or a combination thereof.

Aspect 19: An apparatus for data processing, comprising: a processor; memory coupled with the processor; and instructions stored in the memory and executable by the processor to cause the apparatus to perform a method of any of aspects 1 through 18.

Aspect 20: An apparatus for data processing, comprising: at least one means for performing a method of any of aspects 1 through 18.

Aspect 21: A non-transitory computer-readable medium storing code for data processing, the code comprising instructions executable by a processor to perform a method of any of aspects 1 through 18.

It should be noted that the methods described above describe possible implementations, and that the operations and the steps may be rearranged or otherwise modified and that other implementations are possible. Furthermore, aspects from two or more of the methods may be combined.

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

Information and signals described herein may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, electrically erasable programmable ROM (EEPROM), compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

What is claimed is:

1. A method for data processing, comprising:
acquiring telemetry data for a plurality of client systems supported by a cloud service that controls electronic communications between the plurality of client systems and a plurality of users associated with the plurality of client systems;
receiving an indication of one or more attributes associated with a first client system supported by the cloud service;
filtering the plurality of client systems to identify a set of one or more client systems having attributes that satisfy a similarity threshold with respect to the one or more attributes associated with the first client system;
determining a configuration for the first client system based at least in part on the telemetry data associated with the set of one or more client systems;
executing at least one communication process flow that controls electronic communications between the first client system and two or more users associated with the first client system in accordance with the configuration; and
obtaining telemetry data for the first client system based at least in part on executing the at least one communication process flow in accordance with the configuration.

2. The method of claim 1, further comprising:
generating third-party telemetry benchmarks for the first client system based at least in part on first-party telemetry data associated with the set of one or more client systems, wherein the third-party telemetry benchmarks are used to determine the configuration for the first client system.

3. The method of claim 2, further comprising:
transforming the first-party telemetry data associated with the set of one or more client systems into projected third-party baseline data for the first client system, wherein the third-party telemetry benchmarks are derived from the projected third-party baseline data.

4. The method of claim 1, further comprising:
updating the configuration of the first client system according to the telemetry data obtained from executing the at least one communication process flow.

5. The method of claim 1, further comprising:
removing at least one client system from the set of one or more client systems based at least in part on the telemetry data obtained from executing the at least one communication process flow.

6. The method of claim 1, further comprising:
adding at least one client system to the set of one or more client systems based at least in part on the telemetry data obtained from executing the at least one communication process flow.

7. The method of claim 1, further comprising:
generating a performance score for the first client system and a confidence interval associated with the performance score based at least in part on performing one or more matrix validation operations, segmentation procedures, and benchmarking processes on the telemetry data obtained from executing the at least one communication process flow.

8. The method of claim 7, further comprising:
adjusting one or more parameters of the at least one communication process flow to increase the performance score of the first client system.

9. The method of claim 1, wherein filtering the plurality of client systems comprises:
identifying the set of one or more client systems based at least in part on using an iterative weighted averaging function to filter the plurality of client systems according to the telemetry data.

10. The method of claim 1, further comprising:
generating one or more proxy values that correspond to performance metrics associated with the first client system, wherein the one or more proxy values are based at least in part on the telemetry data obtained from executing the at least one communication process flow.

11. The method of claim 10, further comprising:
determining whether the configuration of the first client system affected an outcome of the at least one communication process flow based at least in part on comparing the one or more proxy values to corresponding proxy values associated with the set of one or more client systems.

12. The method of claim 1, further comprising:
storing the telemetry data in a first-party computing environment that is inaccessible to third-party cloud service providers.

13. The method of claim 1, further comprising:
updating the set of one or more client systems by iteratively comparing the telemetry data obtained from the at least one communication process flow to historic telemetry data obtained from communication process flows associated with the set of one or more client systems.

14. The method of claim 1, wherein:
the set of one or more client systems are hosted in a first-party computing environment supported by the cloud service; and
the first client system is hosted in a third-party computing environment supported by an external cloud service provider.

15. The method of claim 1, wherein the at least one communication process flow is executed using compute resources provided by the cloud service or compute resources provided by a third-party cloud service provider.

16. The method of claim 1, wherein the one or more attributes comprise a geographic location of the first client system, a size of the first client system, a category of the first client system, a quantity of customers associated with the first client system, or a combination thereof.

17. The method of claim 1, wherein the telemetry data comprises request volume information, error metrics, timing information, request saturation data, or a combination thereof.

18. The method of claim 1, wherein the configuration comprises a hardware configuration, a software configuration, a quantity of compute resources, a geographic distribution of compute resources, or a combination thereof.

19. An apparatus for data processing, comprising:
a processor;
memory coupled with the processor; and
instructions stored in the memory and executable by the processor to cause the apparatus to:
acquire telemetry data for a plurality of client systems supported by a cloud service that controls electronic communications between the plurality of client systems and a plurality of users associated with the plurality of client systems;
receive an indication of one or more attributes associated with a first client system supported by the cloud service;
filter the plurality of client systems to identify a set of one or more client systems having attributes that satisfy a similarity threshold with respect to the one or more attributes associated with the first client system;
determine a configuration for the first client system based at least in part on the telemetry data associated with the set of one or more client systems;
execute at least one communication process flow that controls electronic communications between the first client system and two or more users associated with the first client system in accordance with the configuration; and
obtain telemetry data for the first client system based at least in part on executing the at least one communication process flow in accordance with the configuration.

20. A non-transitory computer-readable medium storing code for data processing, the code comprising instructions executable by a processor to:
acquire telemetry data for a plurality of client systems supported by a cloud service that controls electronic communications between the plurality of client systems and a plurality of users associated with the plurality of client systems;
receive an indication of one or more attributes associated with a first client system supported by the cloud service;
filter the plurality of client systems to identify a set of one or more client systems having attributes that satisfy a similarity threshold with respect to the one or more attributes associated with the first client system;
determine a configuration for the first client system based at least in part on the telemetry data associated with the set of one or more client systems;
execute at least one communication process flow that controls electronic communications between the first client system and two or more users associated with the first client system in accordance with the configuration; and
obtain telemetry data for the first client system based at least in part on executing the at least one communication process flow in accordance with the configuration.
